(19) United States
(12) Patent Application Publication
(10) Pub. No.: US 2003/0169690 A1
(43) Pub. Date: Sep. 11, 2003

(54) System and method for separating communication traffic

(76) Inventor: James A. Mott, Oakland, CA (US)

Correspondence Address: DANIEL VAUGHAN, PARK, VAUGHAN & FLEMING LLP, 702 MARSHALL STREET, SUITE 310, REDWOOD CITY, CA, 94063, US

(21) Appl. No.: 10/091,746

(22) Filed: Mar. 5, 2002

(51) Int. Cl. H04J 1/16

(52) U.S. Cl. 370/238; 370/230

(57) ABSTRACT

A system and method for segregating communication traffic to prevent a first type of communications (e.g., best-effort, connection-less, UDP) from limiting or restricting the amount of bandwidth available to a second type (e.g., flow-controlled, connection-oriented, TCP). Either or both types of communications are conducted in separate sets of channels corresponding to an Ethernet quality or class of service, an InfiniBand virtual lane, an ATM virtual circuit or other logical channel.

### BACKGROUND

This invention relates to the field of electronic communications. More particularly, a system and methods are provided for separating communications to prevent one type of traffic (e.g., best-effort) from limiting or restricting the amount of bandwidth available to another type of traffic (e.g., flow-controlled).

Many communication protocols support or provide built-in methods for controlling the flow of communication traffic. Typically, some form of connection is established between two entities. The protocol specifies the format of communications sent between them, and how to control the rate of transmission. For example, TCP (Transport Control Protocol) is a popular connection-oriented protocol that employs flow control to prevent an originating node from flooding or overwhelming a destination node. If the destination is congested or is otherwise not capable of handling communications at the rate dispatched by the originator, the originating node will decrease its rate of transmission.

Other communication types or protocols do not require formal flow control. These types of communications may be termed “best-effort,” because nodes, switches and other devices that handle them simply make their best effort to transmit the communications. UDP (User Datagram Protocol) is an illustrative connectionless protocol that does not employ formal flow control. UDP packets may be dropped or delayed without causing irreparable damage to the stream of data or information they carry. If a packet is dropped, UDP does not require its automatic re-transmission, unlike a flow-controlled protocol.

Because flow-controlled communication streams employ formal restraints on their rates of transmission, and best-effort communications do not, best-effort traffic can sometimes crowd flow-controlled communications and prevent them from receiving optimal or adequate bandwidth. In particular, if a node in a flow-controlled communication connection throttles back its rate of communication, the bandwidth given up by that connection may be absorbed or appropriated by best-effort traffic. As long as best-effort communications are busy and continue to use that bandwidth, a flow-controlled communication connection cannot regain it.

One attempted solution to this problem involves the over-allocation or over-supply of bandwidth. For example, a network segment or environment that could have been implemented to provide 10 Mbps bandwidth may be built to provide 100 Mbps instead. This scheme can easily become very expensive. And, even in over-allocated networks, funnel points exist where several streams of data from different points converge to a single point. Over-allocation does not solve this problem. In addition, communication traffic has a tendency to grow to fill the available bandwidth. Thus, over-allocation may help avoid congestion or conflict between different types of communications only temporarily.

### SUMMARY

Therefore, in one embodiment of the invention a system and methods are provided for separating best-effort and flow-controlled network communications, or other types of conflicting (or potentially conflicting) communications. In this embodiment, a flow-controlled communication connection may be assigned or mapped to one bandwidth-constrained communication channel, or set of channels, while a best-effort stream of traffic may be assigned to a different bandwidth-constrained channel or set of channels.

In different embodiments of the invention, the communication channels may correspond to InfiniBand virtual lanes, ATM (Asynchronous Transfer Mode) virtual circuits, Ethernet quality of service (QoS) queues, or other means of separating one logical channel of communication from another logical channel on the same physical link.

In an embodiment of the invention, a device (e.g., communication interface, switch, router, node, hub, repeater) capable of transmitting electronic communications across a communication link receives a communication (e.g., packet) for transmission. The device identifies a type, category or class that includes or defines the communication. Different types of communications are defined for communications that may conflict with other types. Thus, one type of communication may comprise packets formatted according to a “best-effort” protocol, while another type may encompass packets formatted according to a protocol that provides flow control.

The outgoing communication may then be queued or temporarily stored in a buffer corresponding to its identified type. Thus, best-effort packets may be queued separately from packets susceptible to built-in flow control. Depending on the communication's type, it is transmitted across a corresponding channel of the communication link.

Similarly, in another embodiment of the invention, a communication device is configured to receive communications of a first type (e.g., best-effort, connectionless) across a first channel of a communication link, and receive communications of a second type (e.g., flow-controlled, connection-oriented) across a second channel. Yet another embodiment of the invention may be implemented in a communication environment involving two conflicting schemes or mechanisms for flow control.

### DESCRIPTION OF THE FIGURES

FIG. 1 is a graph demonstrating how best-effort communications can expropriate bandwidth from flow-controlled communications.

FIG. 2 demonstrates the separation of best-effort and flow-controlled communications at an originating node, in accordance with an embodiment of the invention.

FIG. 3 is a flowchart demonstrating one method of segregating conflicting types of electronic communications, according to one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and methods are provided for separating or segregating different types of electronic communications. Traffic separation may help prevent one type of communication from dominating a communication link or unfairly limiting use of the link by another type of communication.

In one implementation of this embodiment, communications are separated or segregated according to whether or not they are formatted according to a protocol that provides a built-in method of flow-control. One type of traffic that does not provide flow control may be termed “best-effort” because an originator of such traffic simply makes its best effort to deliver a communication. Best-effort communication schemes generally do not provide for flow control or automatic retry of lost communications. Protocols that may be considered of the best-effort type include UDP (User Datagram Protocol).

Communications formatted according to a protocol that provides built-in flow control may be considered “flow-controlled.” Illustratively, flow-controlled communications include those adhering to TCP (Transport Control Protocol) or SCTP (Stream Control Transmission Protocol).

In another embodiment of the invention, traffic may be separated on the basis of other distinctions. For example, connectionless communications may be separated or segregated from connection-oriented communications. Or, communications that require a specified bandwidth may be separated from other traffic that does not.

In an embodiment of the invention, each type of communication being separated or segregated is assigned to a different set of communication channels or pipes. The channels may comprise InfiniBand virtual lanes or service levels, ATM (Asynchronous Transfer Mode) virtual circuits or virtual paths, Ethernet QoS (Quality of Service) queues, differentiated services or classes of service, etc. Because each channel, or set of channels, is allotted a particular portion of the bandwidth of a communication link, one type of communication cannot appropriate bandwidth from another. Other embodiments of the invention may be implemented for other communication technologies that provide for the logical separation of communications carried on a common physical link.

In a present embodiment of the invention, multiple types of traffic (e.g., best-effort and flow-controlled) are separated from other types or categories of traffic and assigned to separate channels of a communication link. In other embodiments, just one type of traffic (e.g., best-effort or flow-controlled) is segregated by assigning it to its own communication channel. Other traffic or types of communications may share another channel or the remaining link bandwidth.

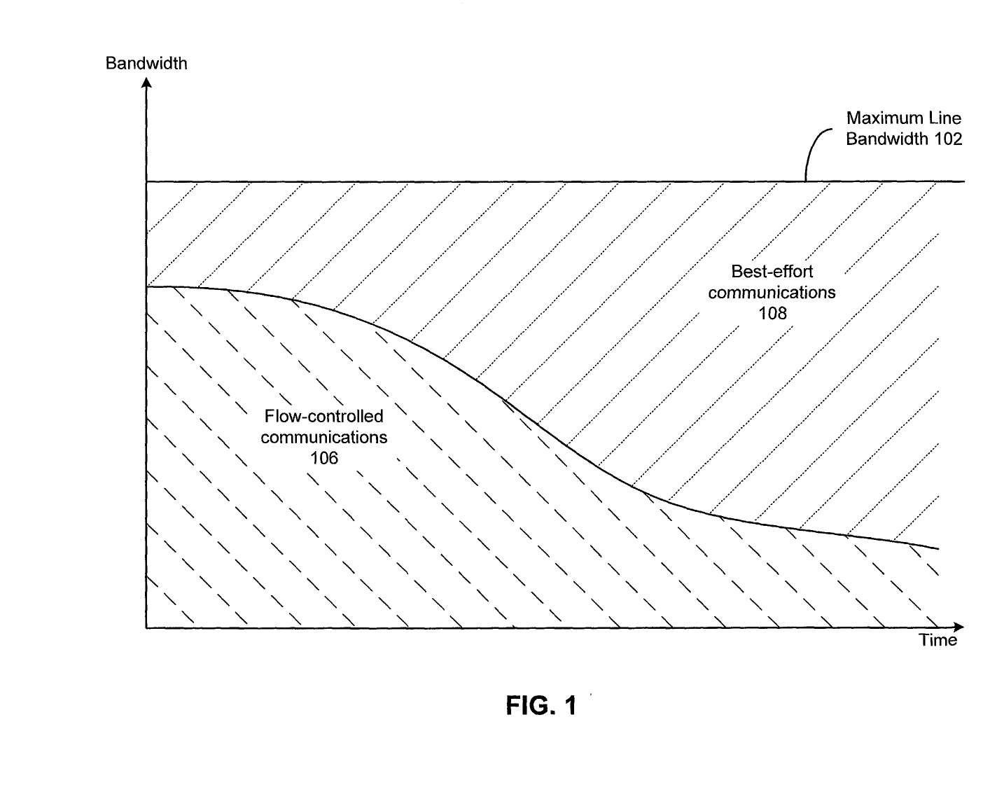

FIG. 1 is a graph demonstrating how non-flow-controlled (e.g., best-effort) traffic can, over time, come to dominate the bandwidth offered by a communication link shared with flow-controlled traffic, even when the flow-controlled traffic initially uses more. In FIG. 1, maximum bandwidth 102 represents the maximum bandwidth the link can provide. Flow-controlled portion 106 represents the portion of the maximum bandwidth used by flow-controlled communications (e.g., TCP traffic). Best-effort portion 108 represents the portion of the maximum link bandwidth used by best-effort communications (e.g., UDP traffic).

As the graph reveals, best-effort traffic tends to displace flow-controlled traffic. For example, when flow control mechanisms are activated for flow-controlled communications, the bandwidth given up by the flow-controlled communications may be seized by the best-effort traffic.

Even though an applicable network or other policy may dictate that TCP or other flow-controlled form of communication should have precedence over best-effort traffic, because they are sharing a link the best-effort communications may crowd the flow-controlled communications.

An embodiment of the invention described herein is particularly suited for implementation in a communication network that hosts UDP and TCP traffic. However, embodiments of the invention suitable for other protocols (whether at the transport layer or some other layer) may be derived from this description.

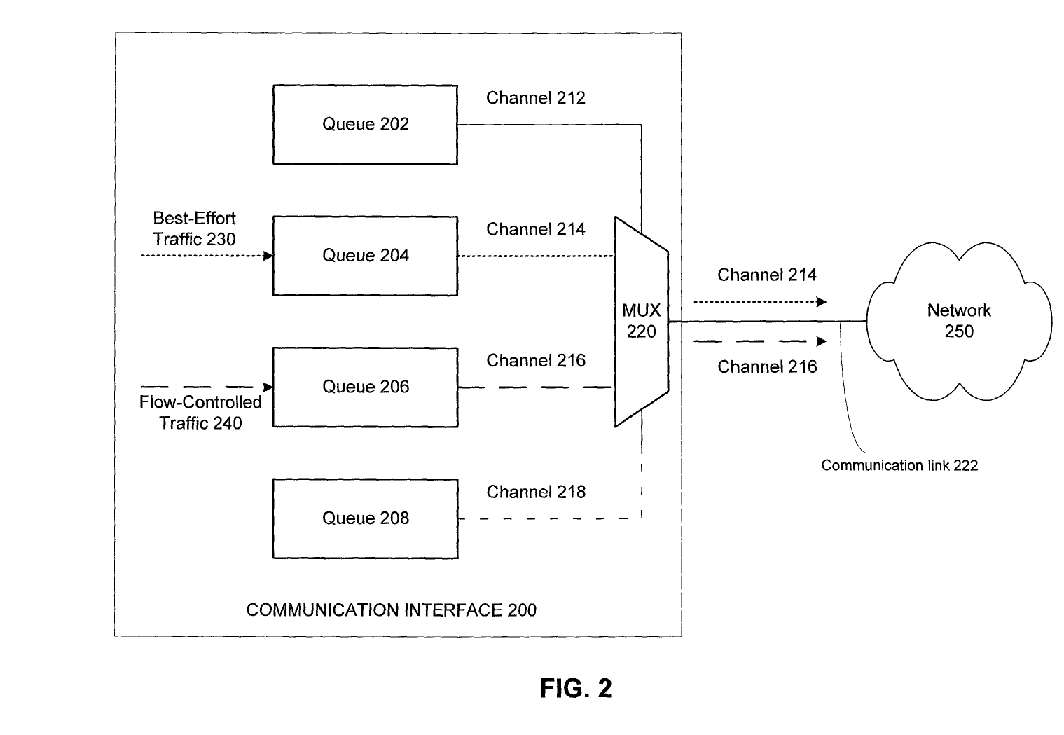

FIG. 2 depicts the separation of network communications based on their type, according to one embodiment of the invention. In the embodiment of FIG. 2, different communication channels are assigned to best-effort traffic and flow-controlled traffic. Illustratively, best-effort traffic comprises communications such as UDP packets. Flow-controlled traffic may include TCP packets.

Communication interface 200 may comprise a network interface card (e.g., for Ethernet or ATM), a target channel adapter or host channel adapter for InfiniBand, or some other type of interface device or module installable in a host computer or other network node (e.g., switch, hub, router, repeater). In other embodiments of the invention, communication interface 200 may be installed in some other device configured for temporary or permanent connection to a network segment or other communication link. Thus, communication interface 200 may serve as the originating transmitter of a best-effort or flow-controlled communication, or may be a switch or other device that re-transmits the communication.

Communication link 222 is a physical link coupling communication interface 200 to network 250, which may be the Internet, some other wide-area network, or a smaller network (e.g., an organization's intranet or local area network). Communication link 222 may comprise a wired (e.g., copper, fiber) or wireless (e.g., RF, laser, microwave) link, and may comprise a segment of network 250 or a link connecting communication interface 200 to a node of network 250. Communication link 222 is configured to support, or carry, one or more logical communication channels.

Communication interface 200 comprises multiple queues for storing communications (e.g., frames, packets, cells) prior to their transmission by the communication interface over communication link 222. In particular, in the illustrated embodiment of the invention, communication interface 200 includes at least two queues, one for best-effort traffic 230 and one for flow-controlled traffic 240. The communication interface may also include other queues for other types of traffic.

In FIG. 2, best-effort traffic is stored in queue 204, while flow-controlled traffic is placed in queue 206. In the illustrated embodiment, outgoing network traffic is queued (or classified for queuing) by a device driver, protocol processor, network management software or other means capable of identifying different types of communications. In particular, a device driver for communication interface 200 may be configured to identify different types of outgoing communications and route them to the appropriate queues. Alternatively, a network management module may be configured to operate outside the protocol stack of the device driver and assign outgoing communications to their appropriate queues. Compatible network management software modules include SNMP (Simple Network Management Protocol) and CMIP (Common Management Information Protocol). Other management protocols configured to segregate traffic, or mark communications for separation, may be employed.

Queues 202, 204, 206, 208 may be assigned weights or priorities commensurate with a network or other policy. Illustratively, if flow-controlled traffic is desired to have higher precedence than best-effort traffic, queue 206 for the flow-controlled traffic may be prioritized higher than queue 204 for best-effort traffic.

Each of queues 202, 204, 206, 208 is coupled to multiplexer 220 by a different logical communication channel, including channel 214 for best-effort traffic from queue 204 and channel 216 for flow-controlled traffic from queue 206. Multiplexer 220 receives outgoing communications from the queues, through their respective channels, and transmits them over communication link 222 to network 250. Multiplexer 220 may service multiple channels in any suitable fashion (e.g., round-robin, according to priorities associated with the channels or queues).

As described above, the communication channels that carry segregated traffic in an embodiment of the invention may be associated with, or correspond to, different entities for different network or communication technologies. Illustratively, a communication channel in an InfiniBand environment may comprise or be associated with a virtual lane, service level or queue pair. In an ATM network, a channel may correspond to a virtual circuit or virtual path. In an Ethernet environment, a channel may represent a particular quality of service, differentiated service or class of service.

In yet other technologies, a communication channel may correspond to some other entity or construct. The communication channels employed in an embodiment of the invention may be separated, defined or limited according to time- or frequency-division multiplexing or some other method. Thus, the bandwidth or communication rate of a channel may be limited or controlled, depending on how the channel is defined, established or maintained.

Although FIG. 2 depicts a single queue and channel for each segregated type of traffic (e.g., best-effort, flow-controlled), in an alternative embodiment of the invention, multiple queues and/or channels may be allotted or provided for a particular type of traffic.

Further, the embodiment of FIG. 2 demonstrates the separation of best-effort and flow-controlled communications. Best-effort traffic in this embodiment may comprise any or all communications that are conveyed according to protocols that do not have flow-control built in or that do not automatically retry a communication that was lost. In other embodiments of the invention, other types of traffic may be segregated. For example, in one alternative embodiment of the invention, traffic may be separated on the basis of whether it is connectionless or connection-oriented.

After outgoing traffic from communication interface 200 reaches network 250, the extent to which it remains segregated may depend on the number and type of devices (e.g., switches, routers, hosts) the traffic visits. For example, if a device (or device port or interface) is configured with an insufficient number of virtual lanes, virtual circuits, QoS queues or other mechanisms for segregating traffic, communications that were separated by communication interface 200 (or a previous device) may have to share one communication channel. This may also occur if the device operates according to a policy that does not require the traffic to be segregated or that segregates it according to a different policy.

However, an embodiment of the invention may be implemented on a network device (e.g., switch, router, host) to separate traffic that was previously merged or carried in a single logical communication channel. Thus, if a first device, upstream from a second device, originates different types of traffic on one channel, or merges or combines previously separated traffic, or simply conveys traffic that was merged by a previous device, the second device may separate the traffic. This separation may mirror a separation scheme implemented by an originator of the traffic, or some other upstream device, or may serve as the initial point of separation.

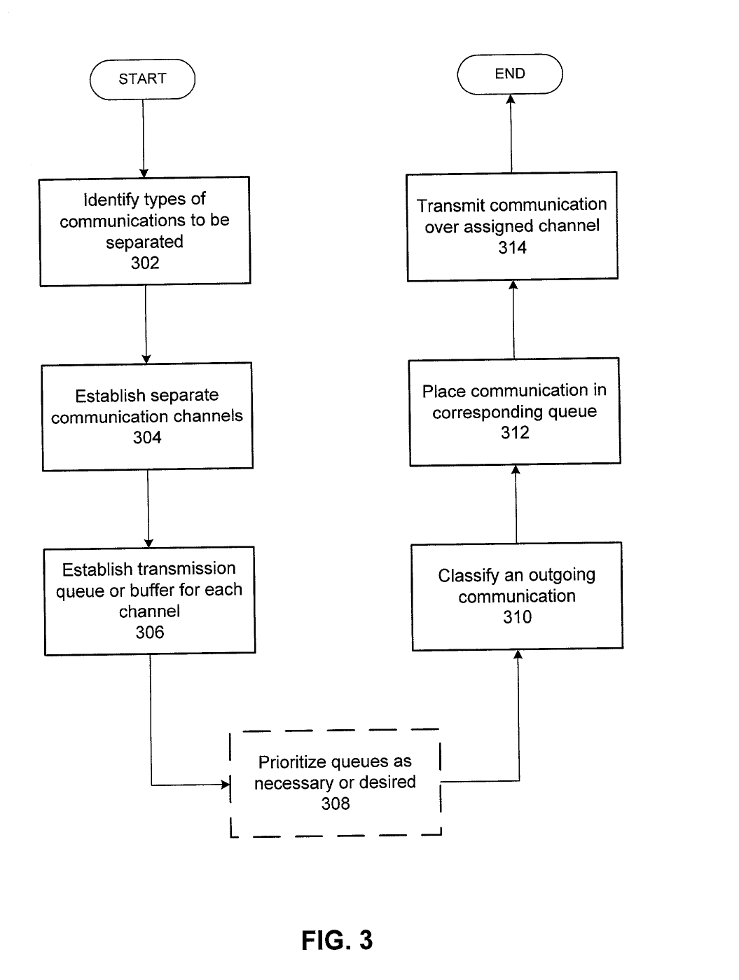

FIG. 3 demonstrates one method of separating classes or types of communication traffic that may otherwise conflict or result in an unfair distribution of communication bandwidth, according to one embodiment of the invention. Traffic to be separated may comprise one or more types or classes of communications conforming to virtually any communication protocols.

Illustratively, communications may be segregated based on whether they are best-effort or flow-controlled, connectionless or connection-oriented, or some other criteria. For example, communications may be separated on the basis of their content (e.g., real-time, time critical), an associated application (e.g., electronic mail, streaming audio or video) or whether they are automatically retransmitted if lost.

In state 302, the type(s) of communications to be separated are identified. In particular, each type that is to receive a separate communication channel or pipe is identified. Thus, a network policy may be generated or implemented to allot one channel or set of channels to flow-controlled communications. Another set may be desired for another type of traffic (e.g., best-effort).

In state 304, separate channels are created for each type of traffic identified in state 302. The channels may be defined at just one device, for just one communication link or network segment, for multiple devices across a wide-area network, or on any other scale.

In state 306, a device (e.g., host, switch, router), or a port or communication interface of the device, is configured with one or more queues or buffers (e.g., one for each channel).

In state 308, the queue may be prioritized or weighted to implement a desired precedence or priority. Queue priorities may influence the order or manner in which they are serviced (e.g., to transmit their outgoing communications).

In state 310, an outgoing communication is received. Its type, if one of those being separated, is identified.

In state 312, the outgoing communication is placed in a queue corresponding to its types. And, in state 314, the communication is transmitted.

One skilled in the art will appreciate that FIG. 3 reflects just one possible method of implementing an embodiment of the invention to separate communication traffic.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

What is claimed is:

1. A method of separating traffic in a communication network, comprising:
receiving a communication to be transmitted across a communication link;
if said communication is a best-effort communication, transmitting said communication on a first channel of the communication link; and
if said communication is a flow-controlled communication, transmitting said communication on a second channel of the communication link.

2. The method of claim 1, wherein said communication is a flow-controlled communication if said communication is configured according to a communication protocol that provides flow control.

3. The method of claim 1, wherein said communication is a best-effort communication if said communication is not configured according to a communication protocol that provides flow control.

4. The method of claim 1, wherein:
the communication network supports InfiniBand communications; and
said first channel and said second channel comprise separate virtual lanes.

5. The method of claim 1, wherein:
the communication network supports Asynchronous Transfer Mode communications; and
said first channel and said second channel comprise separate virtual circuits.

6. The method of claim 1, wherein:
the communication network supports Ethernet communications; and
said first channel and said second channel comprise separate classes of service.

7. A computer readable storage medium storing instructions that, when executed by a computer, cause the computer to perform a method of separating traffic in an electronic communication network, the method comprising:
receiving a communication to be transmitted across a communication link;
if said communication is a best-effort communication, transmitting said communication on a first channel of the communication link; and
if said communication is a flow-controlled communication, transmitting said communication on a second channel of the communication link.

8. A method of separating network traffic, comprising:
receiving a best-effort communication across a first channel of a communication link; and
receiving a flow-controlled communication across a second channel of the communication link;
wherein said flow-controlled communication is a communication configured according to a protocol that provides flow control.

9. The method of claim 8, wherein said first channel and said second channel comprise separate InfiniBand virtual lanes.

10. The method of claim 8, wherein said first channel and said second channel comprise separate ATM (Asynchronous Transfer Mode) virtual circuits.

11. The method of claim 8, wherein said first channel and said second channel comprise separate Ethernet classes of service.

12. A computer readable storage medium storing instructions that, when executed by a computer, cause the computer to perform a method of separating network traffic, the method comprising:
receiving a best-effort communication across a first channel of a communication link; and
receiving a flow-controlled communication across a second channel of the communication link;
wherein said flow-controlled communication is a communication configured according to a protocol that provides flow control.

13. A method of segregating network communications, comprising:
(a) identifying a first type of communication capable of conflicting with another type of communication if both types of communication share a communication channel;
(b) establishing a first channel over one or more communication links;
(c) configuring a device to transmit said first type of communication over said first channel;
wherein said first type of communication is capable of conflicting with a second type of communication if one of said first type of communication and said second type of communication tends to deprive the other of bandwidth.

14. The method of claim 13, wherein said first type of communication comprises a best-effort communication and said second type of communication comprises a flow-controlled communication.

15. The method of claim 14, wherein said flow-controlled communication is a communication formatted according to a protocol that supports flow control.

16. The method of claim 14, wherein said best-effort communication is a communication formatted according to a protocol that does not inherently support flow control.

17. The method of claim 14, further comprising:
repeating steps (b)-(c) for said second type of communication.

18. The method of claim 13, wherein said first type of communication comprises UDP (User Datagram Protocol) communications and said second type of communication comprises TCP (Transport Control Protocol) communications.

19. The method of claim 13, wherein said first type of communication comprises a communication formatted according to a connectionless protocol and said second type of communication comprises a communication formatted accordingly to a connection-oriented protocol.

20. A computer readable storage medium storing instructions that, when executed by a computer, cause the computer to perform a method of segregating network communications, the method comprising:
(a) identifying a first type of communication susceptible to conflict with another type of communication if both types of communication share a communication channel;
(b) establishing a first channel over one or more communication links;
(c) configuring a device to transmit only said first type of communication over said first channel;
wherein said first type of communication is susceptible to conflict with a second type of communication if one of said first type of communication and said second type of communication tends to deprive the other of bandwidth.

21. In a communication network, a method of separating best-effort communications and flow-controlled communications, comprising:
configuring one or more devices in the network to distinguish between best-effort communications and flow-controlled communications;
establishing a first communication channel and a second communication channel through a first portion of the network;
configuring said one or more devices to transmit said best-effort communications on said first communication channel; and
configuring said one or more devices to transmit said flow-controlled communications on said second communication channel.

22. A method of separating different types of communications for transmission across a single physical communication link, comprising:
identifying one or more types of communications to be separated from another type of communication;
for each of said one or more types of communications, establishing an associated logical channel on the physical link;
configuring a first device with a queue for each of said logical channels, wherein said first device coupled to the physical link;
receiving at said first device a first communication to be transmitted over the physical link, wherein said communication is of a first type;
storing said first communication in a first queue associated with a first logical channel, wherein said first logical channel is associated with said first type of communication; and
transmitting said first communication over the physical link in said first logical channel.

23. The method of claim 22, further comprising:
assigning, at said first device, a first priority to said first queue associated with said first logical channel.

24. The method of claim 22, further comprising:
receiving at said first device a second communication to be transmitted over the physical link, wherein said communication is of a second type;
transmitting said second communication over the physical link in a second logical channel.

25. The method of claim 24, wherein:
said first type of communication comprises a best-effort communication; and
said second type of communication comprises a flow-controlled communication.

26. The method of claim 24, wherein:
said first type of communication comprises a connectionless communication; and
said second type of communication comprises a connection-oriented communication.

27. A computer readable storage medium storing instructions that, when executed by a computer, cause the computer to perform a method of separating different types of communications for transmission across a single physical communication link, the method comprising:
identifying one or more types of communications to be separated from another type of communication;
for each of said one or more types of communications, establishing an associated logical channel on the physical link;
configuring a first device with a queue for each of said logical channels, wherein said first device coupled to the physical link;
receiving at said first device a first communication to be transmitted over the physical link, wherein said communication is of a first type;
storing said first communication in a first queue associated with a first logical channel, wherein said first logical channel is associated with said first type of communication; and
transmitting said first communication over the physical link in said first logical channel.

28. An apparatus for transmitting best-effort communications on a first channel and flow-controlled communications on a second channel of a communication link, comprising:
a transmitter configured to transmit electronic communications on a communication link, wherein the communication link is configured to support multiple channels;
a first queue for storing best-effort communications prior to transmission by said transmitter;
a second queue for storing flow-controlled communications prior to transmission by said transmitter; and
identifying means for differentiating said best-effort communications from said flow-controlled communications
wherein said transmitter is configured to transmit said best-effort communications on a first channel of the communication link; and
wherein said transmitter is configured to transmit said flow-controlled communications on a second channel of the communication link.

29. The apparatus of claim 28, wherein said identifying means comprises a set of executable instructions for communication management.

30. The apparatus of claim 28, wherein said identifying means comprises a device driver for the apparatus.

31. The apparatus of claim 28, wherein said first channel and said second channel comprise distinct virtual lanes within an InfiniBand network.

32. The apparatus of claim 28, wherein said first channel and said second channel comprise distinct virtual circuits within an ATM (Asynchronous Transfer Mode) network.

33. The apparatus of claim 28, wherein said first channel and said second channel comprise distinct classes of service in an Ethernet network.

34. The apparatus of claim 28, wherein said transmitter is configured to transmit only said best-effort communications on said first channel.

35. A network, comprising:
a communication link;
a first channel established on said communication link; and
a second channel established on said communication link;
wherein each of said first channel and said second channel are configured to carry one or the other of best-effort communications and flow-control communications, but not both.

36. The network of claim 35, wherein said flow-control communications comprise a communication formatted according to a protocol that provides flow control.

37. The network of claim 35, wherein said best-effort communications comprise a communication formatted according to a protocol that does not provide flow control.

38. The network of claim 35, wherein said flow-control communications comprise a communication formatted according to a connection-oriented protocol.

39. The network of claim 35, wherein said best-effort communications comprise a communication formatted according to a connectionless protocol.

40. The network of claim 35, wherein said first channel and said second comprise separate InfiniBand virtual lanes.

41. The network of claim 35, wherein said first channel and said second comprise separate ATM (Asynchronous Transfer Mode) virtual circuits.

42. The network of claim 35, wherein said first channel and said second comprise separate Ethernet differentiated services.
